(19) United States
(12) Patent Application Publication
(10) Pub. No.: US 2009/0265180 A1
(43) Pub. Date: Oct. 22, 2009

(54) MACHINE-READABLE END USER LICENSE AGREEMENT WITH AUTOMATED ACCEPTANCE

(75) Inventors: Carl M. Ellison, Seattle, WA (US); Valerie R. See, Snohomish, WA (US); John M. Parchem, Seattle, WA (US); Charles Thomas Lenzmeier, Silverthorne, CO (US); Darryl E. Havens, Kirkland, WA (US); Richard B. Ward, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/106,341

(22) Filed: Apr. 21, 2008

(51) Int. Cl. G06Q 99/00

(52) U.S. Cl. 705/1

(57) ABSTRACT

A method of representing a first end-user license agreement (EULA) offered to a user and automatically responding to a subsequent EULA offered to the user is disclosed. The representation may be in a logical language having parameters corresponding to legal terms of the EULA, logical operators, and the capability to form and nest logical expressions. A logical library may store parameters corresponding to legal terms. A logical expression may be created that corresponds to a user's term preferences, and may be evaluated using the terms of a subsequent EULA to automatically determine the user's acceptance or rejection of the subsequent EULA. A user's application preferences of the logical expressions and terms may be received and used by the method. EULA responses may be signified in a log and/or by sending a record or message to the offering party. A similar method is disclosed for other types of electronic agreements.

### BACKGROUND

An End User License Agreement (EULA) is a memorandum of contract between a producer or vendor of a software product and a user. An End User License Agreement grants the user a software license that indicates the legal terms under which the user may utilize the licensed software. Such terms are commonly known in the art and may include, for example, the maximum number copies of the software that a user is legally allowed to make, distribution restrictions, back-up restrictions, and the like.

EULAs typically contain a plethora of legal material and terms. Reading through a EULA may be time consuming, tedious, and interruptive of the user's experience. For these and other reasons, end-users commonly ignore the specific details and terms of a EULA. More often than not, a user clicks through the terms of a EULA without carefully reading its contents in order to move quickly through the installation and to the use of the software product. The user may not be aware or have a good understanding of every term to which s/he agreed. Moreover, the user may not monitor his/her activity to be compliant with the (cursorily) agreed-to terms of the EULA.

Furthermore, at the present time, no record of a user acceptance of a EULA is sent back to the offering party or vendor. An installing program typically forces a user to accept all terms of a EULA before installation of a software product is allowed to proceed. The installed software product then serves as evidence of the user's acceptance of the EULA. This mechanism, however, does not typically allow a user to selectively agree to individual terms within a EULA, nor does it allow a vendor to receive feedback on specific terms within a EULA that may be problematic to a group of customers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method is disclosed for representing an end-user license agreement (EULA) and automatically responding to a subsequent EULA. The method may represent a EULA by using a logical language having elements such as parameters, logical operators, and nesting capabilities. Elements of the logical language may be combined into a logical expression that corresponds to a set of legal terms or conditions of a EULA to which a user is willing to agree a priori. Evaluation of the logical expression may result in an indication of whether or not the user agrees to the set of legal terms represented in and by the logical expression. The logical expression may be stored and may be used to automatically proxy a user's assent to (or partial or full rejection of, as the evaluation may reflect) corresponding terms of a subsequent EULA

Logical expressions may be created and saved when a user responds to a first EULA. The method may automatically detect the user's responses to various terms of a first EULA and may automatically save them as parameters and logical expression(s) in the logical language. Additionally, a user or a vendor may create and store a default set of term preferences independent of responding to any EULA. An embodiment may also allow the user to create, independent of responding to a EULA, one or more logical expressions reflecting his/her desired combination of term preferences.

The method may also allow the creation and selection of application preferences for each term preference, that is, a user may be able to select or indicate the conditions under which s/he wishes a term preference to be applied.

The method may allow for EULAs in which a portion of the terms are able to be represented in the logical language, and a different portion of the terms are not able to be represented in the logical language. For such EULAs, the embodiment may be used for only the terms that have a corresponding parameter in the logical language. The corresponding parameters may be obtained, for instance, via a definition by the end-user, a definition by the vendor, and/or from a global or local logical language library of parameters. For the terms of the EULA that do not have a corresponding parameter or representation in the logical language, a standard procedure for assent/rejection may be used in conjunction with embodiments of the method.

The method may signify a response to the EULA by using a machine log. Other embodiments of methods of signification may include sending a digital record or a message back to the offering party indicating EULA acceptance, EULA rejection, or partial rejection of a EULA.

The method may monitor for compliance with the terms of an agreed-to EULA, and provide an indication upon detection of a potential non-compliance. The method may allow a vendor to enforce or police some portion of the EULA terms. If a potential non-compliance is about to occur, the user's computer may indicate the potential non-compliance to the vendor.

The steps of the embodiments of the method may be performed by a single computer, such as an end-user's computer or a vendor's computer. The steps may be coordinated between an end-user's computer and a vendor's computer. The steps may also be performed by a website or by a distributed computing system, such as a client-server system, peer-to-peer network or cloud service. Other divisions of labor for the steps of the embodiments of the method may be possible.

The embodiments of the methods described herein do not apply only to EULAs but may also be applied to other types of electronic agreements such as service level agreements, privacy use agreements, non-disclosure agreements and the like. Indeed, certain parameterized legal terms may be common across different types of electronic agreements, for instance, usage of personal information. A user may be able to set his/her default preferences for such common terms, and have them globally applied to any type of electronic agreement.

### DRAWINGS

FIG. 1 illustrates a block diagram of an exemplary computing system that may operate in accordance with the claims;

FIG. 2 illustrates an exemplary logical language, how the parameters of the logical language may map to an electronic agreement, and sample logical expressions in the logical language;

FIG. 3 illustrates an embodiment of a method for representing a EULA in a logical language and automatically responding to a subsequent EULA;

FIG. 4 shows an embodiment of a method for receiving, storing and updating preferences and logical expressions;

FIG. 5 shows an exemplary method of representing an electronic agreement, automatically responding to a subsequent electronic agreement and signifying the response to the electronic agreement; and

FIG. 6 illustrates an exemplary method for monitoring for potential non-compliance with an agreed to electronic agreement, detecting a potential non-compliance, and indicating the potential non-compliance.

### DETAILED DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

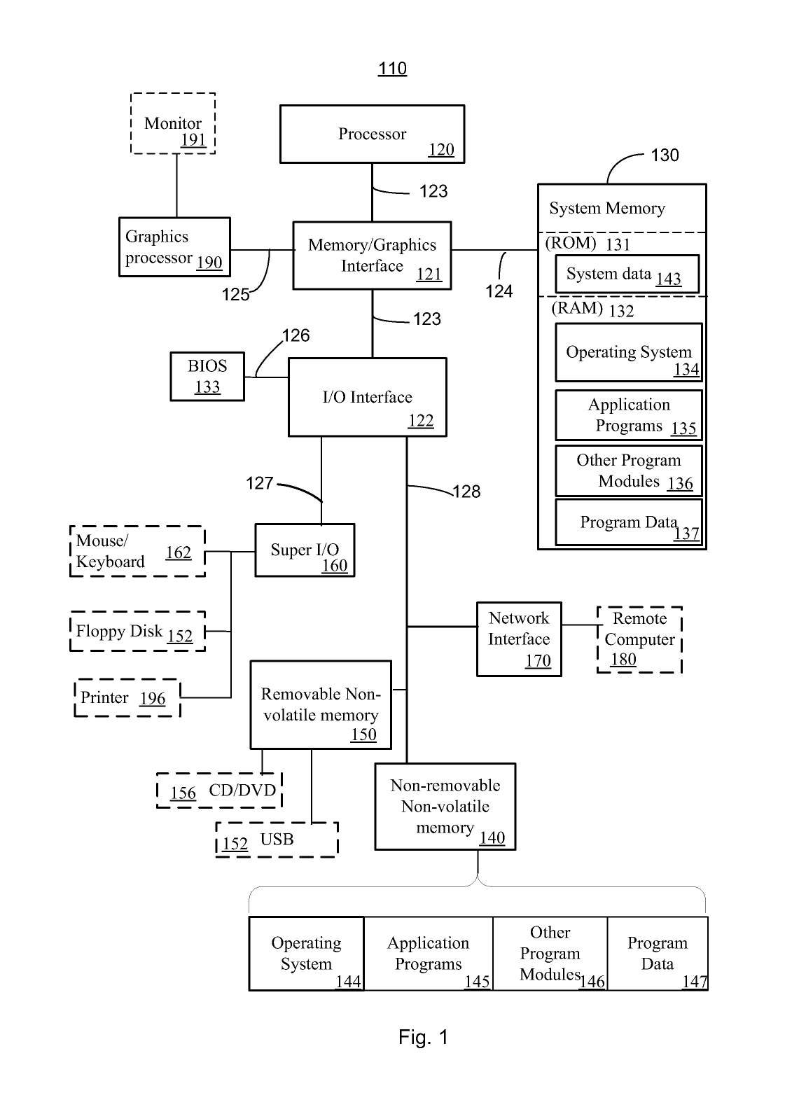

With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a processor 120, a system memory 130, a memory/graphics interface 121, also known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 1 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

A super input/output chip 160 may be used to connect to a number of ‘legacy’ peripherals, such as floppy disk 152, keyboard/mouse 162, and printer 196, as examples. The super I/O chip 122 may be connected to the I/O interface 121 with a low pin count (LPC) bus, in some embodiments. The super I/O chip 121 is widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 1 illustrates a hard disk drive 140 that reads from or writes to non-removable, nonvolatile magnetic media. Removable media, such as a universal serial bus (USB) memory 152 or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a mouse/keyboard 162 or other input device combination. Other input devices (not shown) may include a microphone, joystick, game pad, satellite dish, scanner, or the like. These and other input devices are often connected to the processing unit 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 1 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

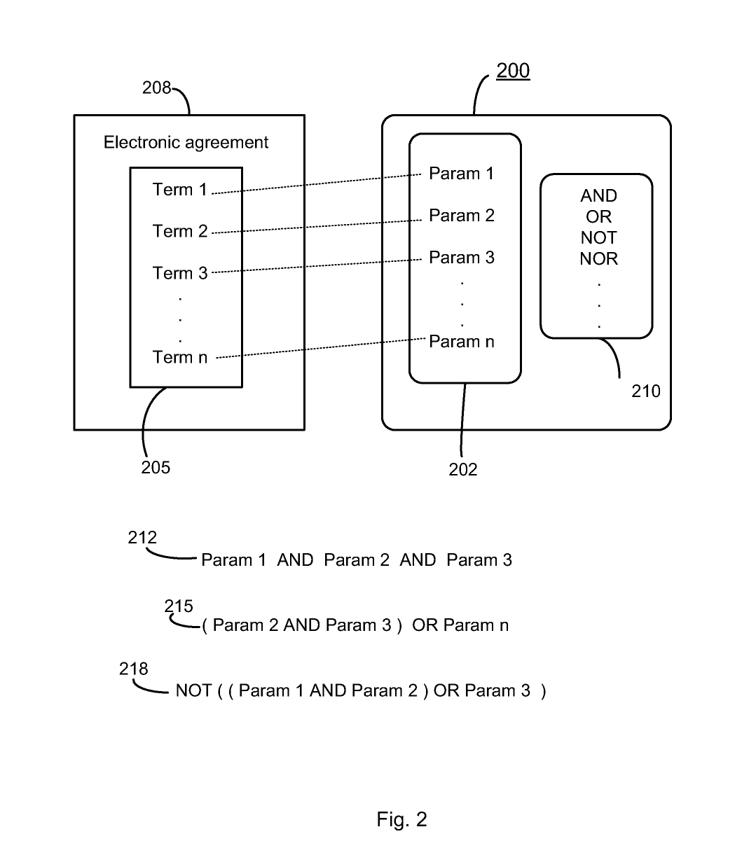

FIG. 2 illustrates an exemplary version of a logical language 200. The logical language 200 may contain a set of parameters 202 where each parameter 202 represents a legal term 205 that may require user assent or rejection and may be used in an electronic agreement 208 between the user and another party. Electronic agreement 208 may be any type of electronic legal agreement or electronic contract between two parties such as an end user license agreement (EULA), a service level agreement, a privacy use agreement, a non-disclosure agreement, and the like. Examples of legal terms 205 may include but are not limited to concepts such as
“do not share personal information with third parties”
“maximum number of downloads”
“supplier not responsible for infringements to third parties if client amends product”
“user is responsible for all charges made under his/her account”
“agreement may be terminated by either party at any time”
“software is provided ‘as-is’”
“permission to migrate this program to a new computer when a user upgrades computers”
“permission to make unlimited backup copies of a program”
   Other legal terms 205 may also be represented in parameterized form. Although the set of legal terms 205 are shown for illustrative purposes in FIG. 2 as part of a single electronic agreement 208, one of ordinary skill in the art will appreciate the set of legal terms 205 may also include legal terms used in any type of electronic agreement 208 and are not limited to the set used in any single electronic agreement 208. Each legal term 205 may have a corresponding parameter 202. The parameters 202 may be defined on an as-needed basis by either of the two parties involved with the electronic agreement. Alternatively or additionally, the parameters 202 may be pre-defined in a global and/or local logical language library, with each parameter 202 corresponding to a legal term 205. A combination of a pre-defined logical language library and definition of parameters on an as-needed basis may be possible.

Logical language 200 may also contain a set of logical operators 210. The set of logical operators 210 may contain logical operators including conjunction (logical-and or AND), disjunction (logical-or or OR), negation (logical-not or NOT), material implication (logical-if or IF, logical-then or THEN), and other logical operators 210 known to one of ordinary skill in the art.

Logical language 200 may provide the capability of combining parameters 202, logical operators 210, nesting and sub-nesting to create logical expressions. Examples of logical expressions are shown by references 212, 215 and 218. For the purposes of the following discussion, logical-true (TRUE) is assumed to represent assent. For example, if a parameter has the value TRUE, the TRUE value indicates that a party agrees to the legal term 205 represented by the parameter 202. Of course, one of ordinary skill in the art will appreciate that assent is not limited to being represented by TRUE and may be represented in multiple ways. In fact, each representation of a party's term preference for each separate parameter 202 may be defined positively or negatively using the logical language 200 to allow flexibility and efficiency. One skilled in the art will also appreciate that each logical expression, similar to the parameters 202, may also be defined positively or negatively using the logical language 200 to allow flexibility and efficiency.

Turning to the examples of logical expressions, reference 212 illustrates a logical expression
Param 1 AND Param 2 AND Param 3
   where Param 1 corresponds to legal term 1, Param 2 corresponds to legal term 2 and Param 3 corresponds to legal term 3. The logical expression shown in reference 212 may correspond to a party's preference to assent to any electronic agreement containing legal terms 1, 2 and 3. Suppose an offered EULA contains at least the legal terms 1, 2 and 3. An embodiment of a method of the present disclosure using logical language 200 may translate the offered electronic agreement into parameters of the logical language, including at least Param 1, Param 2 and Param 3. Using the translated parameters in logical expression 212 may result in an evaluation of TRUE, thus signifying the party's assent. If a different electronic agreement contains legal terms 1 and 2 but not legal term 3, then logical expression 212 as applied to the different electronic agreement may evaluate to logical-false (FALSE), signifying the party's dissent.

Reference 215 illustrates the capability of nesting in a logical expression of the logical language 200. In this example, the logical expression 215 may correspond to a party's preference to assent to any electronic agreement containing either legal term n, or containing both legal terms 2 and 3. Reference 218 illustrates a use of sub-nesting in a logical expression of the logical language. In this example, assent is signified if an electronic agreement does not contain legal term 3 or if the electronic agreement does not contain legal terms 1 and 2. References 212, 215 and 218 are illustrative of the capabilities of the logical language and are not meant to be exhaustive. One of ordinary skill in the art will appreciate the capabilities and flexibility of logical language 200 to represent virtually any combination of legal terms 205 in order to reflect the term preferences of a party.

The default and most commonly used operator 210 may be a conjunction (e.g., logical-and or AND). In an illustrative but not necessarily representative example, if a user wishes to accept all EULAs that allow back-ups and migration to an upgraded computer, a logical expression may be created such as:
backup_param AND migrate_param
   The created logical expression may be stored, for instance, in storage media 130, 140 or 150 of FIG. 1. If a subsequent EULA 208 contains a term 205 that allows back-ups and contains another term 205 that allows migration to an upgraded computer, the translation of the subsequent EULA 208 into the logical language 200 may contain both backup_param and migrate_param. Thus, the logical expression, as applied to the subsequent EULA 208, may evaluate to logical-true (TRUE), thus signifying the user's assent to the terms 205 of the subsequent EULA 208. A response to the subsequent EULA 208 based upon the evaluation of the logical expression may be automatically generated including a proxy assent to the subsequent EULA 208 on behalf of the end-user.

Alternatively, a logical expression may be evaluated negatively to indicate user assent. For instance, a user may want to give assent to any EULA for which no backup copies may be made and no migrations to an upgraded computer are allowed. In this example, if the logical expression
backup_param AND migrate_param evaluates to a value of logical-false (FALSE), then the assent of the user may be signified. If a new EULA 208 contains no term 205 that allows back-ups and no term 205 that allows migrations, the translation of the new EULA into the logical language may not contain backup param and may not contain migrate param. Thus, the logical expression, as applied to the new EULA 208, may evaluate to logical-FALSE (FALSE), thus signifying the user's assent to the terms 205 of the new EULA 208. A response to the new EULA 208 based upon the evaluation of the logical expression may be automatically generated including a proxy assent to the new EULA 208 on behalf of the end-user. One of ordinary skill in the art will appreciate that each representation of a user's preference for each separate parameter 202 may be defined positively or negatively using the logical language 200 to allow flexibility and efficiency. One skilled in the art will also appreciate that each logical expression, similar to the parameters 202, may also be defined positively or negatively using the logical language 200 to allow flexibility and efficiency.

Other logical operators 210 in addition to AND may be possible and desirable, including disjunction (logical-or or OR), negation (logical-not or NOT), material implication (logical-if or IF, logical-then or THEN), and other such logical operators 210 known to one of ordinary skill in the art. Furthermore, the logical language 200 may also provide the capability of nesting and sub-nesting logical expressions as illustrated in examples 215 and 218. By providing an extensive set of logical operators 210 combined with the capability to nest and sub-nest logical expressions, logical expressions may be created to be flexibly, efficiently and accurately portray the legal terms 205 and/or conditions to which a user wishes to give pre-assent.

Logical language 200 may be implemented using computer-executable instructions stored on computer storage media, for instance, removable non-volatile memory 150, non-removable non-volatile memory 140 and/or the system memory 130 of computer 110 as shown in FIG. 1. Computer programs and instructions operating on and with logical language 200 may also be implemented using computer-executable instructions stored on computer storage media. Examples of such computer programs may include logical language libraries, translation programs, user-interface programs, programs that communicate between computers using the logical language, programs that respond to a request for access to the logical language, data storage mechanisms, and the like. Computer programs allowing the translation and/or transfer of information between the software responsible for electronic agreements and the logical language may exist on a computer similar to computer 110 of FIG. 1.

One of ordinary skill in the art will appreciate that one or more portions of logical language 200 may be implemented and/or replicated across different computer storage media 130, 140 and/or 150 of one or more different computers 110, including a computer of one or more users, one or more computers of a vendor, one or more websites, across one or more distributed computing system such as a peer-to-peer network or cloud service, or other computers 110.

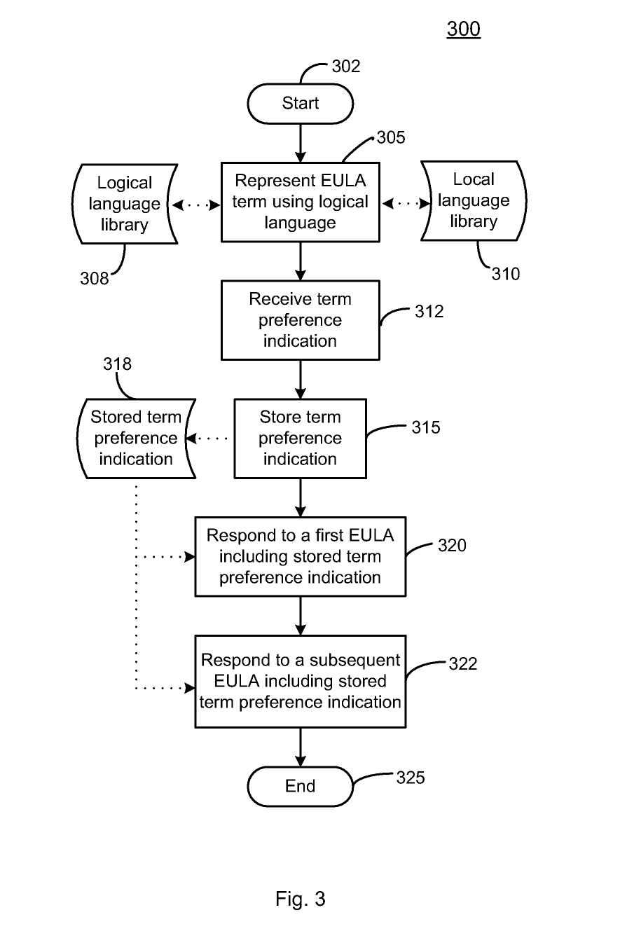

FIG. 3 illustrates an embodiment of a method 300 for representing a EULA in a logical language and automatically responding to a subsequent EULA. At the start of method 300 (block 302), a term of the EULA may be represented using a logical language (block 305), for instance, the logical language 200 of FIG. 2. The term may be translated into the logical language or received directly as a parameter in the logical language form. If a term requires translation, an existing logical parameter may be found for the term by consulting a global logical language library 308 or a local logical language library 310, or a logical parameter may be created for the term on an as-needed basis. A newly created logical parameter may be stored locally 310 or added to a communally accessible logical language library 308.

At block 312, a term preference indication may be received from the party to which the EULA was offered that indicates whether or not the party wishes to assent to the term. The term preference indication may be entered by the party, it may be retrieved from a storage area, it may be received in a message or download, or it may be obtained via some other mechanism or method. The terms “user,” “end-user” and “customer” are interchangeably used herein to denote a person who wishes to install a software product or program onto a computer. Alternatively, “user,” “end-user” and “customer” as used herein may also denote a proxy for the person, such as an administrator assenting to a volume license or another computer program that the user has invoked to perform the installation on his or her behalf. A “vendor,” “offering party,” or “producer” as used herein may be the entity that is providing the software program or product and is offering the EULA to the end-user for acceptance. As used herein, a “vendor,” “offering party,” or “producer” may also be an authorized proxy for the vendor, such as a computer program responsible for downloading or installing the software product or program.

At block 315, the received term preference indication may be stored in a data storage area 318, such as a local storage area (e.g., references 130, 140 and/or 150 of a computer 110 in FIG. 1) or sent (for example, via network interface 170 of computer 110 in FIG. 1) to a remote data storage area or website. Data storage area 318 may or may not be the same entity as storage areas 308 and/or 310. Note that blocks 305, 312 and 315 may be executed as part of processing a specific offered EULA, so that the term may be represented (block 305) and the term preference indication may be received (block 312) and stored (block 315) while processing each specific term of the offered EULA. Alternatively, or additionally, blocks 305 312 and 315 may be executed independent of the offering of a specific EULA, such as while setting up defaults during a during system or program configuration or at any other time.

Next, at block 320, a first EULA may be responded to using the stored term preference indication 318. The response to the first EULA may be automatically created reflecting the stored term preference indication 318 of the party to which the EULA was offered. The response may be sent (block 320) using any known method of sending a response to a EULA, such as an upload, an email, sending a message to a computer of the offering party, entering inputs and/or sending messages to a website of the offering party, or other means. Preferably, but not necessarily, the sending of the response (block 320) may utilize a parallel means corresponding to the means by which the EULA was received.

At some point after block 320, a subsequent EULA with a term corresponding to the stored term preference indication 318 may be offered to the party. The response to the subsequent EULA may be automatically created reflecting the stored term preference indication 318. The subsequent EULA may be responded to reflecting the stored term preference indication 318 (block 322). Finally, at block 325, method 300 may end.

One of ordinary skill in the art will appreciate that an embodiment of the method 300 may be implemented across different computer storage media 130, 140 and/or 150 of different computers 110, for instance on a computer of one or more users, one or more computers of a vendor, a website, across a distributed computing system or other computers 110.

For instance, a global logical language library 308 may reside on a server, website, distributed computing system, or the like that may reside on one or more computers similar to computer 110 of FIG. 1. The global language library 308 may be accessible to and be used by one or more computers similar to computer 110 of one or more end-users to translate a EULA offered by one or more vendors into a logical language, such as logical language 200. The global logical language library 308 or the server on which it resides may also proceed with evaluating user-preferred conditions of assent, or the end-user's computer may receive the translated EULA and perform the evaluation itself. Another example may have the user's computer totally performing every step of an embodiment of method 300, including maintaining a local logical language library 310, and the vendor may be unaware of the logical language 200 altogether.

Alternatively, a vendor may be fluent in the logical language 200 and make available a pre-translated version of its EULA (i.e., offer the EULA in the logical language 200) to the computer of the end-user. A vendor may make use of a global 308 and/or local 310 logical language library to perform the translation. A vendor may present a standard (untranslated) EULA to a user via its website, but use the logical language 200 “behind the scenes” to administer EULA agreements transparent to the user.

Other examples of implementation of the embodiments of the method 300 may include a user and/or a vendor collecting and defining a custom local logical language library 308 310 to reside on his/her/their computer(s). A local logical language library 310 or portion thereof may be unique between a user-vendor pair. Some embodiments of the method 300 may have entities on both the user and the vendor sides that are fluent in the logical language 200 and conversing using logical language 200 regarding EULA agreements. Translation from the logical language 200 into a language readable by a user and/or from a user-readable language into the logical language 200 may be possible. Many other variations and implementations of embodiments of method 300 are also possible.

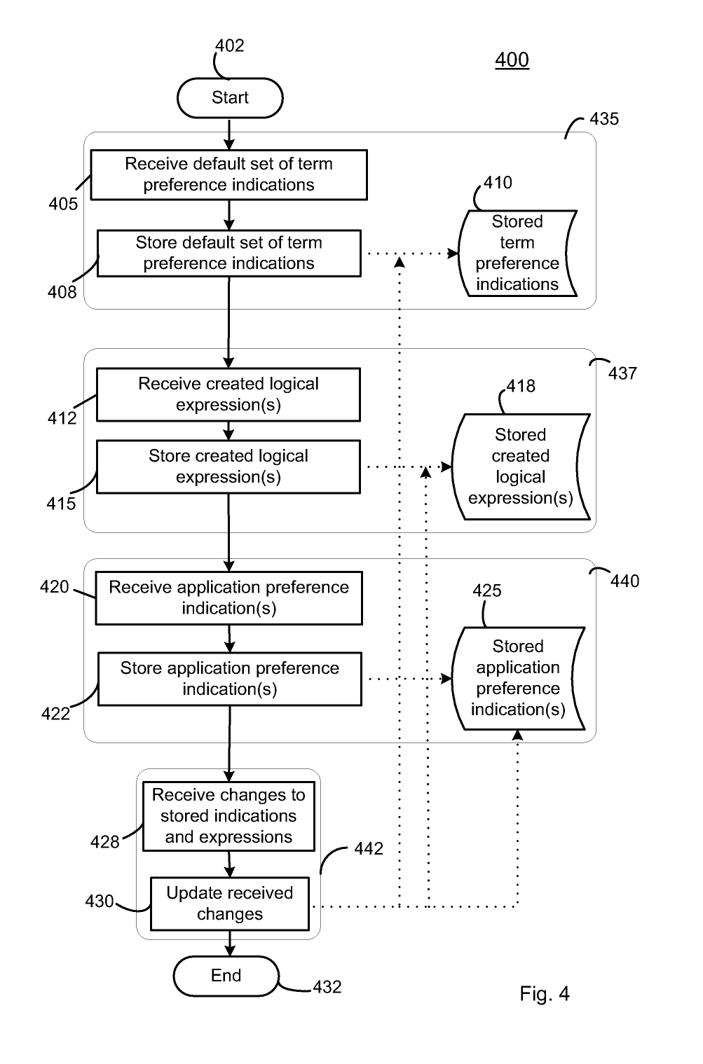

FIG. 4 shows an embodiment of a method 400 for receiving, storing and updating preferences and logical expressions. Method 400 may be used in accordance with logical language 200 of FIG. 2 and with method 300 of FIG. 3. At the start of method 400 (block 402), a default set of term preference indications may be received (block 405). The default set of term preferences may be a set of one or more indications of how a party typically wishes to respond to one or more legal terms. For example, a party may wish to typically reject a term that prohibits copying, typically accept a term that prohibits downloading, and typically reject a term that allows transfer of his/her personal information to a third party. The term preference indications may indicate an end-user's default preferences and may be contained within the default set of term preference indications. The received default set may be entered by the end-user, it may be retrieved from a storage area, it may be received in a message or download, or it may be obtained via some other mechanism or method. If the contents of a received default set are automatically obtained from a user's responses to individual terms of a particular EULA, a confirmation from the user verifying that the obtained term preferences reflect his/her default preferences may be obtained and the user may be allowed to make changes to the automatically obtained default set. At step 408, the received set of term preference indications may be stored, as represented by block 410, in a local database (e.g., references 130, 140 and/or 150 of a computer 110 in FIG. 1) or sent (for example, via network interface 170 of computer 110 in FIG. 1) to a remote data storage area or website. Data storage area 410 may or may not be the same entity as storage areas 308, 310 and/or 318 of FIG. 3.

An embodiment of the method 400 provides for receiving a created logical expression (block 412). The logical expression may be created from a combination of parameters, logical operators, and nesting capabilities as discussed for FIG. 2. One or more of the parameters used in the created logical expression may be retrieved from a storage area such as the logical library 308 and/or local storage 310 of FIG. 3. One or more of the parameters may be defined in real-time during the creation of the logical expression. An offering or a receiving party of a EULA may have the ability to create one or more customized logical expressions for reception by the method 400. Alternatively or additionally, a data storage area such as logical library 308 or local language library 310 may also contain one or more template logical expressions for reception by the method 400. The received created logical expression(s) may be may be entered by a user, vendor or other party, they may be retrieved from a storage area, they may be received in a message or download, or they may be obtained via some other mechanism or method. If one or more logical expressions are automatically created from a user's responses to individual terms of a particular EULA, a confirmation from the user verifying that the created logical expressions reflect his/her preferences may be obtained, and the user may be allowed to make changes to the automatically created logical expressions. At step 415, the received set of created logical expressions may be stored, as represented by block 418, in a local database (e.g., references 130, 140 and/or 150 of a computer 110 in FIG. 1) or sent (for example, via network interface 170 of computer 110 in FIG. 1) to a remote data storage area or website. Data storage area 418 may or may not be the same entity as local storage 308, 310 and/or 318 of FIG. 3, and may or may not be the same entity as storage area 410.

At step 420, one or more application preference indications may be received. An application preference indication reflects the conditions under which a party wishes a term preference indication and/or a logical expression to be applied. Examples of application preference indications may include an indication to only apply the term preference indication and/or logical expression to the current EULA, or to the current and all future EULAs. Other application preference indications may include an indication to apply a logical expression or a term preference indication to only products offered by a specific company, for instance, to only EULAs offered by Company Ajax. An application preference may indicate a preference to apply a logical expression or a term preference indication to only to specific types of products, for example, to only accounting software or to only music downloading software. An application preference indication may indicate that a term preference indication is to be applied in conjunction with one or more other term preference indications, for example, only allow sharing of personal information to third parties for EULAs for accounting software offered by Company Ajax. An application preference indication may indicate that a previously applied application preference indication is to be modified. Other application preference indications may be possible. Multiple combinations of application preferences for each term preference indication or set of term preference indications may be selected and/or indicated.

An application preference indication may apply to a single term preference or to a created logical expression, or it may apply to a group of term preferences and/or logical expressions. An application term preference may be received as each term preference and/or logical expression is received, for instance, by prompting the user each time s/he enters a new term preference into a default set or each time s/he creates a new logical expression. An application term preference may be received in conjunction with a response to an individual term in an offered EULA. Application preference indications may be entered by a user, they may be retrieved from a storage area, they may be received in a message or download, or they may be obtained via some other mechanism or method. At step 422, the received application preference indication(s) may be stored, as represented by block 425, in a local database (e.g., references 130, 140 and/or 150 of a computer 110 in FIG. 1) or a remote data storage area or website. Data storage area 425 may or may not be the same entity as local storage 308, 310 and/or 318 of FIG. 3 and/or data storage areas 410 and 418.

At any time, the method 400 may receive changes to stored term preference indications 410, stored logical expressions 418 and/or stored application preference indications 425 (block 428). These changes may be received, for example, via a user or vendor input, a download, a message, a data transfer, or some other mechanism. The method 400 may then update the stored data found in 410, 418 and/or 425 to reflect the received changes (block 430). Finally, at block 432, the method 400 may end.

One of ordinary skill in the art will notice that every block shown in FIG. 4 may not need to be executed by every embodiment of the method 400. One implementation of the embodiment of method 400 may include receiving, storing and updating term preference indications (e.g., blocks 405, 408, 428 and 430) but may not include receiving, storing and updating application preference indications (e.g., blocks 420, 422). Another implementation may include receiving, storing and updating application preference indications (e.g., blocks 420, 422, 428 and 430) but may not include receiving, storing and updating created logical expressions (e.g., blocks 412, 415). Summarily, the groups of blocks regarding term preference indications (aggregately represented by block 435), logical expressions (aggregately represented by block 437) and application preference indications (aggregately represented by block 440) may be executed separately or in combination with another group. The group of blocks (aggregately represented by block 442) regarding receiving changes and updating stored data may also be optional in an embodiment of method 400, but if block 442 is executed, it may be done so in conjunction with at least one of blocks 435, 437 or 440.

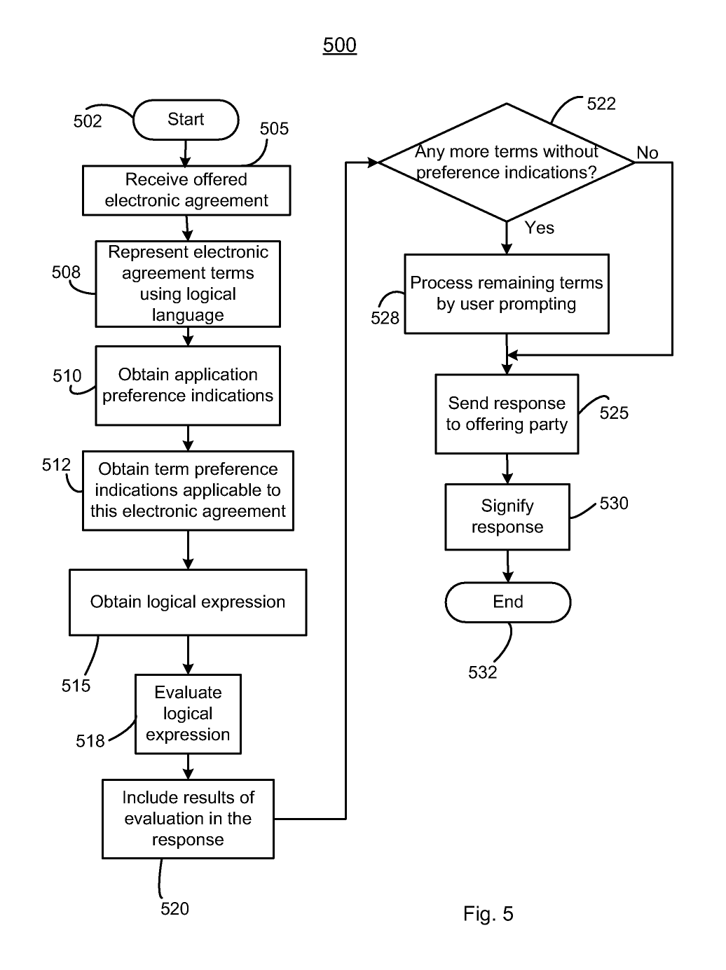

FIG. 5 shows an exemplary method 500 of representing an electronic agreement, automatically responding to a subsequent electronic agreement and signifying the response to the electronic agreement. Electronic agreements may include any contract between two parties that may be agreed to electronically, including agreements such as service level agreements, privacy agreements, end user license agreements, non-disclosure agreements and the like. Embodiments of method 500 may operate in accordance with logical language 200 and methods 300 and 400. At the start of method 500 (block 502), an offered electronic agreement may be received (block 505). The electronic agreement may be received via any known electronic means, including a download, a displayed page on a website, an opened window during installation of a software product, an email, a message, or other electronic means.

Next, at block 508, the terms of the electronic agreement may be represented using a logical language, such as logical language 200 described in FIG. 2. The representation of the terms may be entirely or partially executed by translating terms of the electronic agreement, for example, by accessing a logical language library such as global logical language library 308 or a local storage such as reference 31O. The representation may be entirely or partially executed by creating, in real-time, a parameter for each legal term of the electronic agreement. The created parameters may be stored into a logical language library 308 or a local storage area 310, or sent (for example, via network interface 170 of computer 110 in FIG. 1) to a remote data storage area or website.

Representing the terms of the electronic agreement in a logical language (block 508) may also be executed by receiving the electronic agreement directly in a parameterized, logical language. A combination of translating parameters, creating parameters and receiving parameters directly in the logical language may be used to complete block 508.

At block 510, application preference indications may be obtained. Application preference indications may be obtained through accessing a storage area such as reference 425. Application preference indications may be obtained in real-time from the party to which the electronic agreement is offered, such when storage area 425 is empty, does not exist or if the party wishes to override one or more stored application preference indications. In some embodiments, obtaining application preference indications (block 510) may be omitted from method 500.

Next, at block 512, term preference indications for each of the parameterized terms in the electronic agreement may be obtained. Term preference indications may be obtained through accessing a storage area such as reference 410. Term preference indications may be obtained in real-time for each parameter, such as when parameters are created in real-time or if storage area 410 is empty, does not exist, or if the party to which the electronic agreement is offered wishes to override one or more stored term preference indications. Note that if application preference indications were obtained in block 510, only the term parameter indications that apply to the electronic agreement per the application preference indications may need be obtained.

At block 515, a logical expression may be obtained. The logical expression may be in a logical language such as logical language 200. The logical expression may be obtained through accessing a storage area such as reference 418. The logical expression may be obtained in real-time from the party to which the electronic agreement is offered, such as if storage area 418 is empty, does not exist, or if the party wishes to override a stored logical expression. Note that if application preference indications were obtained in block 510, only the logical expressions that apply to the electronic agreement per the application preference indications may need be obtained.

At block 518, the obtained logical expression may be evaluated using the term preference indications obtained in block 512. The results of the evaluation may be included in the response to the offered electronic agreement (block 520), thus including a reflection of the offered party's preferences to the parameterized terms in the response.

If all terms of the electronic agreement are able to be represented by parameters of the logical language, and the representative parameters have corresponding term preference indications as determined at block 522, then the response to the electronic agreement, including the results of the evaluation at block 520, may be sent to the party that offered the electronic agreement (block 525). If the electronic agreement contains terms that are not able to be represented by parameters, or if there are terms represented by parameters but without corresponding term preference indications as determined at block 522, then said terms may be processed using a standard method of electronic agreement response, such as “click-to-use” or some other known method in the art (block 528). The response to the electronic agreement may then be sent to the offering party (block 525) where the response includes both a portion whose response to the terms was automatically determined (for example, using all or some subset of the group of blocks 505, 508, 510, 512, 515, 518 and 520), and a portion whose response was composed using a standard response method.

Sending the response to the offering party (block 525) may be executed using any known method of sending a response to an electronic agreement, such as an upload, an email, sending a message to a computer of the offering party, entering inputs and/or sending messages to a website of the offering party, or other means. Preferably, but not necessarily, the sending of the response (block 525) may utilize a parallel means corresponding to the means in which the electronic agreement was received (block 505) from the offering party. Note that with method 500, sending the response (block 525) may not need to be limited to responding only when an electronic agreement is fully accepted. A full or partial rejection may be sent to the offering party (block 525). The full or partial rejection may contain a listing of individual terms and an indication of if the party to which the electronic agreement was offered agreed to or rejected each individual term. An embodiment of method 500 thus allows an offering party the ability to collect data on how customers respond to specific terms of offered electronic agreements.

At block 530, the response may be signified. In the present art, no record of EULA assent is typically recorded; the installation of a software product implies user assent to all term of its corresponding EULA. An embodiment of the method 500 includes signification of the response (block 530), be it an assent or a partial or full rejection. Signification of the response (block 530) may be executed by recording an entry in a machine log corresponding to the response, including pertinent information such as type of electronic agreement, product to which the electronic agreement applies, serial number, date and time of response, method and/or location of response (for instance, if the EULA was accepted at a home machine, public machine, website or other), a log of the response to each individual term of the electronic agreement, the identification of a machine or a user, and other pertinent information. The contents of the log entry may be selectable. The machine log may be stored on a computer of the user and/or vendor such as computer 110 of FIG. 1, the machine log may be stored on a website or remote data storage area, or it may be stored on a computer of a third party, for instance, a third party vendor that manages information storage for the user and/or the vendor.

Signification of the response (block 530) may also be executed by sending, to the offering party, a digital record corresponding to the response. Similar to the machine log entry, the digital record may contain pertinent information such as type of electronic agreement, product to which the electronic agreement applies, date and time of response, method of response, identification of the responding party, name and serial number of the product, and a log of the response to each individual term of the electronic agreement. The contents of the digital record may be selectable. Signification of the response (block 530) may also be executed by sending, to the offering party, a message corresponding to the response including a digital signature of the sender, e.g., the user or the computer of the user. The contents of the message may be selectable. Other ways of signification are also possible. Of course, multiple ways of signification may be combined for a single response, for instance, making an entry in a machine log and sending a digital record.

By signifying the response (block 530), a positive record of the electronic agreement and corresponding response may exist, and the vendor may be enabled to obtain data regarding responses to individual terms of its offered electronic agreements. One of ordinary skill in the art will note that in some embodiments of method 500, signification of the response (block 530) may not need to be executed.

If a vendor chooses to receive digital records and/or messages regarding electronic agreement acceptance/rejection records, an embodiment of the method provides to the ability to gather aggregate data for each term of the electronic agreement. For example, a vendor may discover, via data gleaned from the signification of electronic agreement responses, that a consequential number of customers rejected their electronic agreement based on a certain term. The vendor may further be able to distinguish term rejections based upon electronic agreement type, product, product category and/or other conditions. Currently, a vendor does not have a mechanism to distinguish specific reasons for electronic agreement rejection, and in some cases, does not even have knowledge that a electronic agreement was rejected. With the present disclosure, however, the vendor may be provided with a mechanism to actively determine that electronic agreement rejections occurred as well as discover more granular reasons behind electronic agreement rejections. With the present disclosure, vendors are now able to receive and use this data to provide a business advantage.

Similar to a vendor, a user may also be able to take advantage of signification of a response (block 530). A user may be able to retrieve a record of a response that was at least partly automatically generated. A user may also be provided with the capability of retrieving aggregate data across one or more signified responses (block 530). Finally, at block 532, method 500 may end.

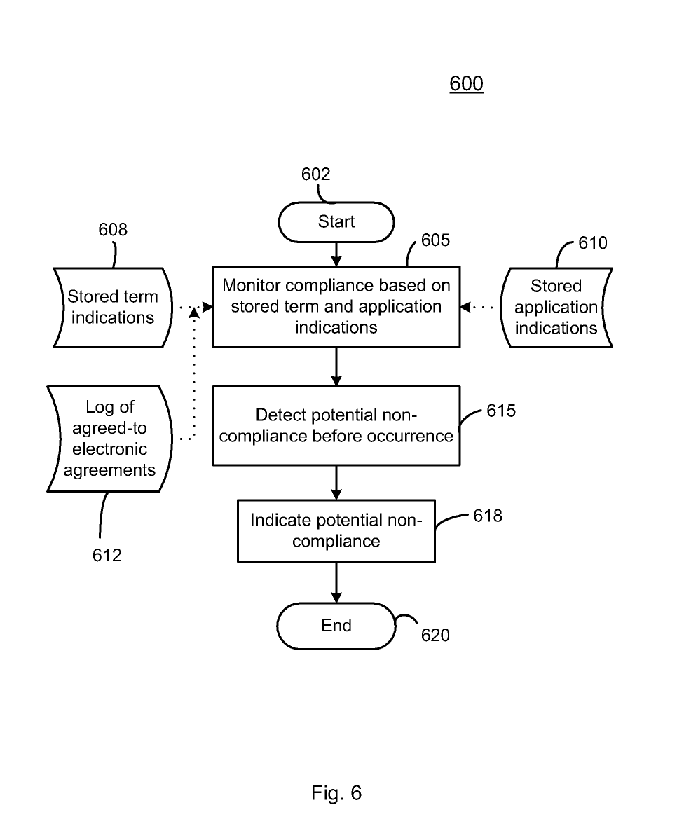

FIG. 6 illustrates an exemplary method 600 for monitoring for potential non-compliance with an agreed-to electronic agreement, detecting a potential non-compliance, and indicating the potential non-compliance. Embodiments of method 600 may operate in accordance with logical language 200 and methods 300, 400 and 500. At the start of method 600 (block 602), an embodiment of the method may monitor for compliance, as represented by block 605, based on stored term preference indications 608 and/or stored application preference indications 610. Stored term preference indications 608 may or may not be the same entity as reference 410 of FIG. 4, and stored application preference indications 610 may or may not be the same entity as reference 418 of FIG. 4. Alternatively or additionally, an embodiment of method 600 may monitor for compliance (block 605) based on stored entries of responses to previously agreed-to electronic agreements 612. The log of stored responses 612 may be, for instance, the same entity as reference 530 of FIG. 5.

At block 615, a potential non-compliance to an agreed-to term of an electronic agreement may be detected. Examples of potential non-compliances may include requesting too many downloads, an attempt to copy software, an attempt to modify software, and the like. The method 600 may then indicate the detection of the potential non-compliance (block 618). Embodiments of method 600 may use one or more ways of indication, including a pop-up window, a message, a sound, an email, an entry in a log, a flashing icon, and other ways of indication.

For example, consider a scenario where a user has pre-assented and agreed to download four backup copies of a software program GeeWhiz via a EULA for software program GeeWhiz. The agreed-to EULA is stored at the user's computer, for example, in storage area 612. The terms of the agreed-to EULA are thus known and monitored for compliance (block 605). If the user tries to make a fifth backup of the software program GeeWhiz, this potential non-compliance may be discovered (block 615) and indicated (block 618), for instance, via a pop-up window: “Per the EULA for software program GeeWhiz, you assented on Mar. 30, 2007 at 20:04 CST to download a maximum of four copies of software program GeeWhiz. Previous downloads occurred on dates A, B, C, and D. Do you wish to continue with the fifth download?” Other mechanisms of indication (block 618) may be possible, such as a sound, email or other message, logging the potential non-compliance, or complete blocking of the desired action. The indication(s) (block 618) may be selectable and able to be turned on and off.

If a user ignores or overrides the indication of potential non-compliance, a message or other indication may be sent from the user's computer to the vendor signifying the non-compliance. Thus, an embodiment of method 600 may act as an enforcer for some or all of the terms of the EULA agreement. Of course, the enforcing may be implemented only after full disclosure and agreement to the enforcing is obtained between the user and the vendor. Alternatively, a vendor may use the indication of potential non-compliance as an upsell opportunity. Continuing with the previous example of the fifth download of software program GeeWhiz, the pop-up window may display: “A fifth download of GeeWhiz may be available for an additional agreement and fee. Click here for more details.”

Finally, method 600 may end (block 620).

One of ordinary skill in the art will appreciate that an embodiment of methods 300, 400, 500 and 600 may be implemented across different computer storage media 130, 140 and/or 150 of different computers 110, for instance across one or more of a computer of one or more users, one or more computers of a vendor, one or more websites, across a distributed computing system such as a peer-to-peer network or cloud service, or other computers 110. Storage of user preferences such as references 410, 418 and 425 of FIG. 4 and machine logs such as used by step 530 of FIG. 5 may also use one or more of the user's computer, the vendor's computer, one or more websites, a distributed computing system, or other storage mechanisms.

The methods of the present disclosure save time for a user during software installations and other occasions where electronic agreements must be processed before proceeding to the task at hand. The methods free the user from having to engage in each and every electronic agreement that is presented to him/her and enables the user to move more quickly to his/her ultimate goal of using the software or continuing with his/her desired task.

The methods of the present disclosure also provide several other useful advantages. One advantage of providing signification of EULA and electronic agreement responses is a new ability for vendors to gather feedback and data regarding the individual terms of their EULAs. Another useful advantage of the present disclosure is automatically helping an end-user to be compliant with the terms that s/he agreed to in a EULA or other electronic agreement.

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed:

1. A method of representing a first end-user license agreement (EULA) offered to a user and automatically responding to a subsequent EULA offered to the user, the method comprising:
semantically representing at least one term of the first EULA using a machine-readable form;
receiving a term preference indication of a user preference for the at least one term;
storing the term preference indication using the machine-readable form;
automatically responding to the first EULA including the stored term preference indication; and
automatically responding to the subsequent EULA including the stored term preference indication;
wherein a set of terms of the subsequent EULA is deemed to be accepted by the user if a representative logical expression for the set of terms having a parameter for each member of the set of terms is evaluated to produce a result indicative of a user acceptance of the set of terms, the representative logical expression in the machine-readable form.

2. The method of claim 1, wherein the machine-readable form comprises a logical language having at least one parameter corresponding to the at least one term, at least one logical operator, a capability to create a logical expression from at least one of the at least one parameter and at least one of the at least one logical operator, and a capability to nest logical expressions.

3. The method of claim 1, further comprising allowing an update to the stored term preference indication.

4. The method of claim 1, wherein the term preference indication is stored on at least one of: a computer of the user, a computer of a party offering at least one of the first or the subsequent EULA, a website, or a distributed computing system.

5. The method of claim 1, further comprising:
receiving an application preference indication of a user preference for applying the term preference indication, the application preference indication comprising at least one from a set of application preference indications, the set of application preference indications including:
applying the term preference indication to only a current EULA,
applying the term preference indication to future EULAs,
applying the term preference indication to a EULA offered by a specified party,
applying the term preference indication to a EULA for a specified type of product,
applying the term preference indication in conjunction with another term preference indication, and
removing a previously applied term preference indication;
storing the application preference indication; and
allowing an update to the application preference indication.

6. The method of claim 1, further comprising displaying at least one of the automatic response to the first EULA or the automatic response to the subsequent EULA.

7. The method of claim 1, further comprising signifying the response to the first EULA by performing at least one from a set of steps, the set of steps including:
storing, in a machine log, an entry corresponding to the first EULA's response,
sending, to an offering party of the first EULA, a digital record indicating the first EULA's response, and
sending, to the offering party, a digital signature on a message indicating the first EULA's response.

8. The method of claim 1, further comprising monitoring compliance with the term preference indication included in the response to the first EULA and indicating a potential non-compliant condition prior to an occurrence of the potential non-compliant condition.

9. The method of claim 1, further comprising:
receiving a default set of user term preference indications,
allowing an update to the default set of user term preference indications,
receiving a user application preference indication for each member of the default set, the user application preference indication comprising at least one of:
applying the each member of the default set of user term preference indications to a EULA offered by a specified party,
applying the each member of the default set to a EULA for a specified type of product,
applying the each member of the default set in conjunction with another each member of the default set, or
removing a previously applied user term preference indication;
allowing an update to the user application preference indication of the each member of the default set, and
including the default set of user term preference indications and the user application preference indication for the each member of the default set in the responses to the first and subsequent EULAs.

10. A method of electronically representing a first electronic agreement and automatically responding to a subsequent electronic agreement, the method comprising:
semantically representing at least one term of the first electronic agreement using a machine-readable form, the machine-readable form comprising a logical language including at least one parameter corresponding to the at least one term, at least one logical operator, and a capability to create a logical expression from at least one of the at least one parameter and at least one of the at least one logical operator;
receiving a term preference indication of a user preference for the at least one term;
automatically responding to the first electronic agreement including the term preference indication; and
automatically responding to the subsequent electronic agreement including the term preference indication,
wherein set of terms of the subsequent electronic agreement is deemed to be accepted by the user if a representative logical expression for the set of terms having a parameter for each member of the set of terms is evaluated to produce a result indicative of a user acceptance of the set of terms, the representative logical expression in the machine-readable form.

11. The method of claim 10, wherein the first electronic agreement is one from a set of types of electronic agreements comprising a service level agreement, a privacy use agreement and an end-user license agreement.

12. The method of claim 10, further comprising:
storing the term preference indication on at least one of: a computer of a user to which the first and subsequent electronic agreements are offered, a computer of a party offering at least one of the first or the subsequent electronic agreement, a website, or a distributed computing system, and
allowing an update to the stored term preference indication.

13. The method of claim 10, further comprising:
receiving an application preference indication of a user preference for applying the term preference indication, the application preference indication comprising at least one from a set of application preference indications, the set of application preference indications including:
applying the term preference indication to only a current electronic agreement,
applying the term preference indication to future electronic agreements,
applying the term preference indication to a specified type of electronic agreement,
applying the term preference indication to an electronic agreement offered by a specified party,
applying the term preference indication to an electronic agreement for a specified type of product,
applying the term preference indication in conjunction with another term preference indication, and
removing a previously applied term preference indication;
storing the application preference indication; and
allowing an update to the application preference indication.

14. The method of claim 10, further comprising signifying the response to the first electronic agreement by at least one of:
storing, in a machine log, an entry corresponding to the first electronic agreement's response,
sending, to an offering party of the first electronic agreement, a digital record indicating the first electronic agreement's response, and
sending, to the offering party of the first electronic agreement, a digital signature on a message indicating the first electronic agreement's response.

15. The method of claim 10, further comprising monitoring compliance with the term preference indication included in the response to the first electronic agreement and indicating a potential non-compliant condition prior to an occurrence of the potential non-compliant condition.

16. The method of claim 10, further comprising:
receiving a default set of user term preference indications,
allowing an update to the default set of user term preference indications,
receiving a user application preference indication for each member of the default set, the user application preference indication comprising at least one of:
applying the each member of the default set of user term preference indications to an electronic agreement offered by a specified party,
applying the each member of the default set to an electronic agreement for a specified type of product,
applying the each member of the default set in conjunction with another each member of the default set, or
removing a previously applied user term preference indication;
allowing an update to the user application preference indication of the each member of the default set, and
including the default set of user term preference indications and the user application preference indication for the each member of the default set in the responses to the first and subsequent electronic agreements.

17. A computer-readable medium with computer-executable instructions thereon for a logical language for semantically representing a set of terms of an electronic agreement offered to a party, the logical language comprising:
at least one parameter corresponding to at least one term of the set of terms of the electronic agreement;
at least one logical operator;
a capability to create a logical expression from at least one of the at least one parameter and at least one of the at least one logical operator;
a capability to nest logical expressions; and
a capability to sub-nest logical expressions;
wherein a portion of the set of terms of the electronic agreement is deemed to be accepted by the party if a representative logical expression in the logical language is evaluated to produce a result indicative of the party's acceptance of the portion, the representative logical expression including a representative parameter for each term in the portion.

18. The computer-readable medium of claim 17, further comprising computer-executable instructions for at least one of: allowing a selection of the portion of the set of terms or allowing the party to create the representative logical expression.

19. The computer-readable medium of claim 17, further comprising computer-executable instructions for translating between the logical language and a language readable by the party.

20. The computer-readable medium of claim 17, further comprising computer-executable instructions for allowing access to a library of parameters corresponding to a library of terms used in electronic agreements.
